(19) United States
(12) Patent Application Publication
(10) Pub. No.: US 2007/0136110 A1
(43) Pub. Date: Jun. 14, 2007

(54) METHOD OF TABLE MANAGEMENT

(76) Inventors: Anthony S. Presley, Lubbock, TX (US); Erik van Gilder, Fredericksburg, VA (US)

Correspondence Address: Michael A. O'Neil;Michael A. O'Neil, P.C., Suite 820, 5949 Sherry Lane, Dallas, TX, 75225, US

(21) Appl. No.: 11/560,091

(22) Filed: Nov. 15, 2006

Related U.S. Application Data
(60) Provisional application No. 60/742,204, filed on Nov. 18, 2005.

(51) Int. Cl. G06Q 10/00

(52) U.S. Cl. 705/5

(57) ABSTRACT

A method of table management utilizes a software program to manage the setup for a restaurant on any given date or occasion, prioritize seating, manage waiting lists, manage reservations, and assign seating order based on planning and layout factor information for the restaurant combined with real-time data received from the restaurant.

### CROSS-REFERENCE TO RELATED APPLICATIONS

This application claims priority based on provisional patent application Ser. No. 60/742,204 filed Nov. 18, 2005, the entire content of which is incorporated herein by reference.

### TECHNICAL FIELD

This invention relates to restaurant table management, and more particularly to a method of table management which optimizes table usage and facilitates rapid customer seating.

### BACKGROUND AND SUMMARY OF THE INVENTION

Table management and seating priority at restaurants have heretofore been determined by reservations and by seating customers without a reservation on a first-come, first-served basis. When a new party enters the restaurant and a table is not available to accommodate the number of persons in the party a name associated with the party is placed on a waiting list and the party is seated at the first available table. This strategy for seating customers is intended to reduce the waiting time that undivided parties experience but does not produce the least cumulative waiting time for all customers and therefore results in reduction of revenue for the restaurant.

The traditional first-come, first-served seating strategy is illustrated in the following example. Customer A arrives first and has four (4) persons in his party. The last available table having a capacity for four people was taken by a party of two. Customer B arrives 15 minutes after Customer A and has six (6) persons in her party. Customer C arrives five (5) minutes after Customer B and has only two people in his party. A host/hostess greets all three customers and places them on a waiting list for “first-available” seating because no table is available as they arrive. Five minutes after Customer C arrived, a table which can accommodate six persons becomes available. Although Customer B has six persons in her party Customer A has been waiting longer; therefore Customer A's party is seated at the table, leaving two empty seats at the table. Five minutes after Customer A is seated a table which can accommodate four people becomes available. The waiting list dictates that Customer B should be seated next but the available table cannot accommodate B's party. To seat Customer B first the host/hostess determines whether a nearby table will be available within the next ten minutes that can be combined with the available table to seat Customer B. If no nearby table is available the host/hostess proceeds to Customer C leaving two empty seats. Generally when another table is combined to accommodate Customer B the resulting table has eight available seats leaving two empty seats by seating Customer B.

According to the foregoing example Customer A waited for twenty-five minutes, Customer B waited a minimum of fifteen minutes, and Customer C waited a minimum of ten minutes. The resulting seating arrangement resulted in a minimum of six empty seats, thereby resulting in lost profit for the restaurant. Assuming the minimum order total for each seat is $15.00, the restaurant lost a potential income of $90.00 by following the first-come, first-served strategy.

The foregoing example illustrates the problem of traditional restaurant seating strategy on a very small scale. On any given night a busy restaurant has at least ten to fifteen parties waiting to be seated at any one time in similar circumstances and party numbers as illustrated in the example resulting in ten to fifteen times the monetary loss to a restaurant per night.

The present invention comprises a method of table management which overcomes the foregoing and other difficulties which have long since characterized the prior art. In accordance with the broader aspects of the invention a method of table management utilizes a software program to manage a restaurant setup on any given date or occasion, prioritize seating, manage waiting lists, manage reservations, and assign seating based on planning and layout factors for a restaurant and real-time data received from the restaurant.

In accordance with the more specific aspects of the invention a method of table management utilizes a seating layout and seating strategy for optimal table usage and customer throughput. As new customers enter the restaurant, the host/hostess enters the time and number of persons in the customer's party. The software of the present invention computes optimal seating arrangements based on customer information entered by the host/hostess and available restaurant information. Customers are listed in order of seating priority in conjunction with a projected table assignment and estimated waiting time. The seating list is regenerated each time a new customer is scheduled or a new table becomes available.

A restaurant practicing the table management method of the present invention is able to seat customers faster and in a more space efficient manner as compared with existing restaurant management techniques. Applying the table management method to the example described hereinabove would result in each party having a shorter waiting time and fewer empty seats at the tables. The software program projects table availability based on inputs from the host/hostess, wait staff, bussers, and/or kitchen staff, and/or signals received from table monitoring devices and monitoring devices assigned to desired users such that a particular customer is not always seated at the next available table. Instead, the customers are assigned to the next available table which will accommodate the number of persons in their party optimally. As a result the waiting times for all customers decreases thereby causing each customer to have a more enjoyable experience while the restaurant realizes more income.

### BRIEF DESCRIPTION OF THE DRAWINGS

A more complete understanding of the present invention may be had by reference to the following Detailed Description when taken in connection with the accompanying Drawings, wherein:

FIG. 1 is a flowchart illustrating the steps of table management comprising the present invention; and

FIG. 2 is a diagram illustrating the table management system according to the present invention.

### DETAILED DESCRIPTION

### Introduction

The following example describes a method of table management to maximize restaurant revenue while minimizing customer wait time incorporating the present invention.

### EXAMPLE

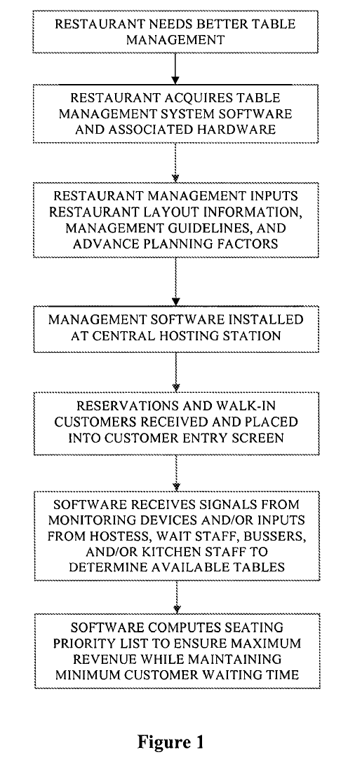

Referring now to the Drawings, and particularly to FIG. 1 thereof, there is shown the steps of the method of table management comprising the table management system of the present invention. A restaurant desiring to better manage layout and seating for optimal customer throughput acquires a provided software program. The software program comprises an input screen for restaurant management to input restaurant information such as restaurant layout information, restaurant management guidelines, and information regarding dates of holidays and special events when the restaurant expects to have more customers than a typical weekday.

The restaurant layout information includes the following items: the physical layout of the restaurant, the number of tables available, the size of each available table, a designation of which tables can be combined to seat groups of people larger than any of the provided tables can accommodate, areas of the restaurant designated for certain activities such as smoking and non-smoking sections, and the service personnel required to service each area and/or table. The restaurant management guidelines include maximum waiting time, the number of times a party may be skipped when seating customers on a wait list, and a preference to rotate the sections in which customers are seated to balance the workload of the service personnel assigned to each section.

Once the restaurant information is entered the software is installed on a central hosting station for use by a host/hostess or a similar employee responsible for taking reservations and greeting and seating walk-in customers. A customer desiring to dine at the restaurant either calls to schedule a reservation, calls ahead to place his/her name on a waiting list, or walks into the restaurant for seating at the earliest available time. A customer scheduling screen is provided in the software program. Customers calling to make a reservation are thereafter scheduled by entering the customer's name, desired reservation time, and number of persons comprising the customer's party into the customer scheduling screen. Call ahead and walk-in customers are entered into the scheduling screen by entering the customer's name, number of persons in the party, and time and date of arrival.

The software comprises an algorithm for computing optimal seating arrangements based on the inputs received from the customer scheduling screen, data received from monitoring devices and/or from inputs generated by restaurant employees, and the restaurant information. The algorithm thereafter computes and generates a customer seating priority list. The customers are listed in order of seating in conjunction with the table assignment and estimated waiting time. The seating priority list is regenerated each time a new customer is scheduled and a new table becomes available.

In accordance with a first embodiment of the invention each table and/or each chair within the restaurant is equipped with a monitoring device for monitoring activity at each table. Each chair is assigned to a predetermined table. The monitoring device comprises a sensor for detecting movement of the table or chair on which it is installed, a microprocessor for processing data from the sensor, a memory chip for storing flash memory thereon, and a transmitter for transmitting data to and from other monitoring devices and/or the central hosting station. The monitoring device may further comprise a light-emitting diode (LED) for indicating whether the device is functioning properly. The power source comprises a battery or similar local power providing device known to those skilled in the art. The monitoring device on each chair assigned to a predetermined table is programmed to communicate with its assigned table only. The table thereafter collects the signals from each chair's monitoring device and communicates a signal to the central hosting station when movement at the table is detected.

In accordance with a second embodiment of the invention monitoring devices are assigned to designated users, such as the host/hostess, wait staff, bussers, or kitchen staff. The assigned monitoring devices are similar to those utilized with respect to tables and chairs, with the exclusion of the sensor for detecting movement, and further comprising a keypad or similar means for entering desired restaurant information and a display for communicating information to the user. The user manually activates the monitoring device to transmit data to monitoring devices assigned to other designated users and/or the central hosting station. The user can also receive data from monitoring devices assigned to other users and/or the central hosting station. In this manner, the user can communicate with restaurant staff and the central hosting station.

The central hosting station comprises a receiver for receiving signals from the tables and/or monitoring device assigned to one or more designated users. Once a signal is received from an identified table and/or monitoring devices assigned to one or more designated users the software processes the signal and notifies the host/hostess of the identified table's activity. The host/hostess can thereby determine that customers have been seated at the identified table or that the table is now free and will be available for seating shortly. The host/hostess thereafter marks the table as seated or empty.

The table monitoring device may further be networked with an order entry system within the restaurant, which links the orders entered and bills paid. The host/hostess station further receives the signals that an order has been entered, served, or the bill paid. Accordingly, the table will be marked as served, paid out, bussed, or empty in the system.

If the table is marked as paid out, bussed, or empty, the table is going to be available for seating shortly, so the software, or, alternatively, the host/hostess indicates in the computer that the table is available and the software recalculates the seating priority list and assigns waiting customers accordingly.

The table monitoring devices, chair monitoring devices, and monitoring devices assigned to designated users are part of a mesh network system of wireless devices. The chair monitoring devices communicate to the table monitoring device which thereafter communicates with the central hosting station via a wireless network. Likewise, the monitoring devices assigned to designated users communicate with the central hosting station via a wireless network. Each table monitoring device is an individual node and likewise the chair monitoring devices each define an individual node. Monitoring devices assigned to designated users would constitute additional nodes.

The central hosting station comprises the network router, which sends and receives messages to and from all nodes. Mesh networks comprise a plurality of wireless communication devices wherein signals sent between the nodes and the network router are re-transmitted by a node in the event the signal did not reach the intended destination. For example, if the network router sends a signal to a node 5, but due to location, the message cannot reach node 5 but does reach a node 4, node 4 will re-transmit the signal to node 5 without reconfiguration or re-transmission by the network router. Mesh networks have been developed by researchers at several universities including Massachusetts Institute of Technology and the University of California at Berkeley, and several companies developing wireless communications. The table management system of the present invention utilizes custom manufactured mesh networking device components similar to those manufactured by Crossbow Technology, Inc.

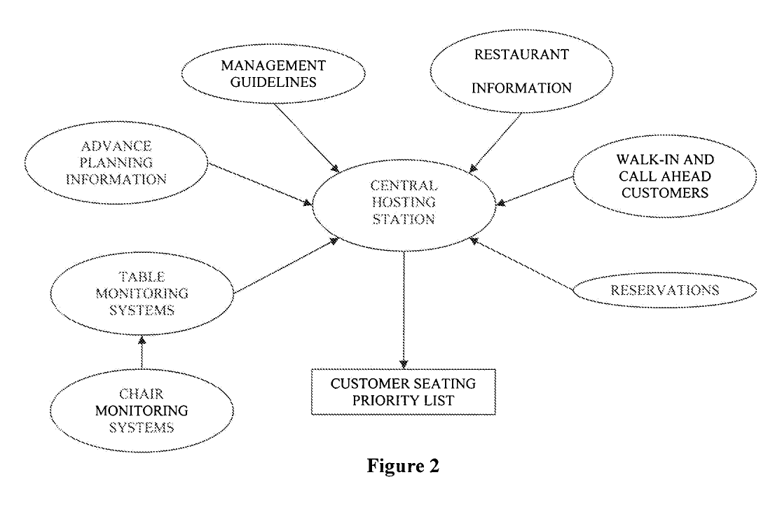

Referring now to FIG. 2, there is shown a diagram of the inputs to the table management system of the present invention. The central hosting station comprising the provided software receives the inputs as described herein and computes a customer seating priority list. As new inputs are received by the central hosting station, the software recomputes the seating priority to achieve maximum revenue realized by the restaurant while minimizing customer waiting time.

Although preferred embodiments of the invention have been illustrated in the accompanying Drawings and described in the foregoing Summary and Detailed Description, it will be understood that the invention is not limited to the embodiments disclosed, but is capable of numerous rearrangements, modifications, and substitutions of parts and elements without departing from the spirit of the invention.

1. A method for managing tables at a restaurant comprising the steps of:
providing a software program having at least one algorithm for computing a customer seating priority list based on inputs;
providing means for inputting restaurant information into the software program;
providing means for receiving reservations;
providing means for recording walk-in customers;
providing means for monitoring table activity; and
utilizing the software to manage seating priority and table layout in accordance with the restaurant information, reservations, walk-in customers, and table activity.

2. The method according to claim 1 wherein the restaurant information comprises restaurant layout information, management guidelines, and advance planning factors.

3. The method according to claim 1 wherein the means for monitoring table activity comprises table monitoring devices.

4. The method according to claim 3 wherein the table monitoring devices are part of a wireless mesh networking system.

5. The method according to claim 1 wherein the means for monitoring table activity comprises monitoring devices assigned to designated users.

6. The method according to claim 5 wherein the monitoring devices assigned to designated users are part of a wireless mesh networking system.
